(19) United States
(12) Patent Application Publication
(10) Pub. No.: US 2010/0233612 A1
(43) Pub. Date: Sep. 16, 2010

(54) CARRIER FOR TWO-COMPONENT ELECTROPHOTOGRAPHIC DEVELOPER AND ELECTROPHOTOGRAPHIC DEVELOPER USING THE CARRIER

(75) Inventors: Tetsuya UEMURA, Kashiwa - shi (JP); Tomoaki KOBAYASHI, Kashiwa-shi (JP); Masashi AOKI, Sakura-shi (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/716,444

(22) Filed: Mar. 3, 2010

(30) Foreign Application Priority Data
Mar. 16, 2009 (JP) 2009-063437

(51) Int. Cl. G03G 9/113

(52) U.S. Cl. 430/111.1

(57) ABSTRACT

A carrier for an electrophotographic developer in which a surface of a carrier core particle is coated with a silicone resin or a modified silicone resin, the coated resin containing a dioctyltin compound, and the silicon content and dioctyltin content in the coating resin satisfy the following expression, and an electrophtographic developer using the carrier.

0.5≦(dioctyltin content/silicon content)×100≦11.0

### TECHNICAL FIELD

The present invention relates to a carrier for a two-component electrophotographic developer used in copying machines and printers, etc., and an electrophotographic developer using the carrier.

### BACKGROUND ART

In the electrophotographic developing system, toner particles must be always triboelectrically charged with a desired polarity by carrier particles and to a sufficient charge amount during long operating use. However, toner particles are fused onto the surface of carrier particles due to collision between carrier particles, mechanical stirring within a developing vessel or heat generation resulting from the collision and stirring. This phenomenon is called “spent toner”. When this phenomenon occurs, the charge properties of the carrier particles decrease with the passage of operating time, followed by occurrence of image deterioration such as photographic fog and toner scattering. If so, the developer itself must be totally replaced by new one.

To prevent occurrence of “spent toner” in a conventional method, the surface of carrier core-material is coated with a resin having low surface energy, such as a fluorine resin and a silicone resin, to obtain a carrier having a long operating life.

However, when a fluorine resin is used as a coating resin, the fluorine resin relatively usefully prevents spent toner; however, the strength of the fluorine coating film is weak and adhesiveness to a carrier core-material is poor. As a result, the coating film is frequently peeled off and resistivity extremely decreases. It becomes difficult to maintain an initial image.

In these circumstances, ferrite carriers coated with various silicone resins (used as a coating resin) have been proposed. Japanese Patent Application Laid-Open No. 60-76754 is directed to imparting a high charging ability to silicone resin itself without impairing a strong function of preventing spent toner, in other words, directed to providing a carrier for a two-component dry-process developer substantially requiring no addition of a polarity-controlling agent to toner and proposes a carrier for a two-component dry-process developer obtained by coating the surface of carrier particles with a silicone resin containing an organic tin compound as a hardening catalyst. Japanese Patent Application Laid-Open No. 2002-23429 is directed to providing a two-component developer whose developing ability is high even if operated at high speed and whose developing ability rarely deteriorates even if an image forming operation is performed for a long time, and proposes a carrier obtained by coating the surface of magnetic particles with a resin containing a conductive carbon and crosslinkable-fluorine modified silicone resin, in which the magnetic particles have an average particle size of 30 to 90 μm and a degree of aggregation of carrier particles within 2 to 15%.

Furthermore, there are patent documents directed to providing a highly reliable carrier (as well as a developer and developing method) free of significant spent toner to carrier even if operated for a long time, causing no charge amount decrease, toner scattering and ground staining, free of significant carrier beads carry over and capable of stably maintaining high quality of an image. Japanese Patent Application Laid-Open No. 2003-280286 proposes a carrier coated with a silicone resin containing a fluorine-containing silane coupling agent and a composition of a positive charge property, in which the carrier has a weight average particle size (Dw) of 25 to 45 μm and the ratio of particles having a particle size less than 44 μm is 70 wt % or more and the ratio of particles having a particle size less than 22 μm is 7.0 wt % or less. Japanese Patent Application Laid-Open No. 2003-280289 proposes a carrier obtained by coating the surface of a magnetic core-material with a film containing a silicone resin, an amino silane coupling agent and a fluorine-containing silane coupling agent.

Furthermore, Japanese Patent Application Laid-Open No. 2003-280290 is directed to providing a carrier for a two component developer having high durability; a carrier for a two-component electrophotographic developer having high durability even if used in combination with a toner containing a mold release agent; an electrophotographic developer; an image forming method; and an image forming apparatus, and proposes a carrier whose particle surface is treated with a single or two or more types of elements selected from a titanate coupling agent, a fluorine-containing silane coupling agent and aceto-alkoxy aluminum diisopropylate, or a carrier having a coating film containing these, in which the particle diameter (D) and film thickness (h) of a binder resin satisfy the relationship:

1<[D/h]<10.

However, recently, toner and an image forming apparatus such as a copying machine have been changed so as to satisfy the requirement for forming a high-quality image. The conventional techniques as mentioned above are insufficient to deal with the change and attain a long life of a carrier.

Recently, to form a high-quality image, the size of toner particles tends to reduce. As the particle size reduces, flowability and charge properties decrease. To improve the deteriorative conditions, an oxide such as silica and titania is added as an external additive to a toner. However, by the addition of such an external additive, spent toner to a carrier easily occurs. Particularly, in the case of a full-color toner, a resin of a low softening point is used in order to improve color-reproducibility and further in the case of a developer using a toner containing wax in order to render the maintenance easier, the amount of spent toner to carrier extremely increases, with the result that the charge amount of toner decreases, and photographic fog and toner scattering are likely to occur. In a full-color electrophotographic system, when the charge amount decreases, image density of a highlight portion easily changes. As a result, high image quality cannot be maintained at present.

Furthermore, it has been demanded that an image forming apparatus such as a copying machine is reduced in size and power consumption. To deal with the demand, studies have been conducted on miniaturization and power-saving of a photosensitive member and a developing vessel, etc. Of them, attention is particularly drawn to a fixing device. In a conventional fixing device, silicone oil or the like is applied to prevent offset of a fixing roller and a recording sheet. Therefore, an oil tank and an oil application apparatus are required, rendering miniaturization of the fixing device to be difficult. To solve this problem, an idea of adding a mold release agent for preventing offset to a toner has been studied. However, the toner containing a mold release agent has a problem in that the mold release agent tends to adhere onto a carrier surface, lowering durability as a developer. In the circumstances, development of a carrier having high durability even if it is used in combination with a toner containing a mold release agent, has been strongly desired.

As described above, in electrophotographic image formation, a carrier for a two-component electrophotographic developer capable of preventing spent toner, free of a significant reduction of charge amount and having excellent durability in long operating use, and an electrophotographic developer using the carrier have not yet been obtained.

### DISCLOSURE OF THE INVENTION

### Problem to be Solved by the Invention

Accordingly, an object of the present invention is to solve the aforementioned problems in the prior art and provide a carrier for a two-component electrophotographic developer capable of preventing spent toner, free of a significant reduction of charge amount and having excellent durability in long operating use, in electrophotographic image formation, and provide an electrophotographic developer using the carrier.

### Means for Solving the Problem

As a result of studies conducted by the present inventors, they found that the aforementioned problems can be solved by adding dioctyltin, in a predetermined amount relative to silicon, to a resin serving as a coating resin of a carrier, using a silicone resin or a modified silicone resin. Based on the finding, the present invention was attained.

More specifically, the present invention provides a carrier for an electrophotographic developer, in which a surface of a carrier core particle is coated with a silicone resin or a modified silicone resin, the coated resin containing a dioctyltin compound, and a silicon content and a dioctyltin content in the coating resin satisfy the following expression:

0.5≦(dioctyltin content/silicon content)×100≦11.0

In the carrier for an electrophotographic developer according to the present invention, a dibutyltin content in the coating resin is desirably 1.0 ppm or less.

Furthermore, the present invention is directed to providing an electrophotographic developer comprising the carrier mentioned above and a toner.

The electrophotographic developer according to the present invention is used as a replenishing developer.

### Effect of the Invention

Use of the carrier for an electrophotographic developer according to the present invention and electrophotographic developer using the carrier in forming an electrophotographic image can prevent toner spent and a significant decrease of charge amount during long operating use, thereby improving durability and attaining high speed and full-color operation.

### MODE FOR CARRYING OUT OF THE INVENTION

Mode for carrying out the invention will be described below.

### <Carrier for an Electrophotographic Developer According to the Present Invention>

In a carrier for an electrophotographic developer according to the present invention, the surface of a carrier core particle is coated with a silicone resin or a modified silicone resin.

As the carrier core particle used herein, a core material (particle) conventionally used as a core material for a carrier for an electrophotographic developer, such as an iron powder core material, a magnetite core material, a resin carrier core-material or a ferrite core material is mentioned. Of them, a ferrite core material formed of ferrite particles containing at least one element selected from Mn, Mg, Li, Ca, Sr and Ti is particularly desirable. In consideration of recent tendency toward reducing environmental burden including waste regulation, it is preferred that heavy metals such as Cu, Zn and Ni are not contained beyond the inevitable-impurity (concomitant impurity) range.

Furthermore, when the carrier core particle is formed of a ferrite core material comprising ferrite particles, high-porosity ferrite particles can be also used. In this case, voids of the ferrite particles may be filled with a resin. Such a ferrite carrier filled with a resin can be used.

Furthermore, the volume average particle size (D₅₀) of the carrier core particle is desirably 15 to 80 μm. If D₅₀ falls within this range, carry over of carrier beads is prevented and good quality of an image can be obtained. An average particle size of less than 15 μm is not preferable because carry over of carrier beads is likely to occur. Furthermore, an average particle size exceeding 80 μm is not preferable because image quality is likely to deteriorate.

### (Average Particle Size)

The average particle size is obtained by measuring the size of particles by a micro-track particle size analyzer (Model 9320-X100) manufactured by Nikkiso Co., Ltd., using water as a dispersant medium. A sample (10 g) and water (80 ml) are placed in a 100-ml beaker and a few liquid drops of a dispersant (sodium hexametaphosphate) are added. Subsequently, the mixture is dispersed for 20 seconds by use of an ultrasonic homogenizer (Type UH-150, manufactured by SMT. CO. LTD.) at an output level of 4. Thereafter, foams are removed from the surface of the dispersant medium and the sample is loaded to the apparatus (analyzer).

As the coating resin, a silicone resin or a modified silicone resin as mentioned above is used. More specifically, an unmodified straight silicone resin and modified silicone resins modified with a resin such as an acrylic resin, a polyester resin, an epoxy resin, a polyamide resin, a polyamide-imide resin, an alkyd resin, a urethane resin and a fluorine resin are mentioned.

The coating amount of silicone resin or modified silicone resin relative to the carrier core particle is generally as follows. When a resin is used as a coating resin of a carrier core particle, the coating amount of resin is desirably 0.1 to 3.5 wt % relative to the carrier core particle. Furthermore, when a ferrite carrier is filled with a resin, the amount of resin is desirably 5.0 to 20.0 wt % relative to the ferrite carrier core particle. In this case, the amount of resin is the sum of the filled amount in the voids of particle and the amount of resin coated to the surface of the particle.

In a carrier for an electrophotographic developer according to the present invention, a dioctyltin compound is contained as a hardening catalyst in the coating resin. As the dioctyltin compound, dioctyltin diacetate, dioctyltin dilaurate, dioctyltin dineodecanoate and dioctyltin dioctoate can be exemplified. It is not preferred to use an organic tin compound except a dioctyltin compound as the hardening catalyst, because the state of spent toner deteriorates and the charge amount after a duration test (toner life test) decreases.

The addition amount of dioctyltin compound relative to the coating resin is desirably 1.0 to 10.0 wt % relative to the solid content of the coating resin. When the addition amount of dioctyltin compound is less than 1.0 wt %, the dioctyltin compound contained cannot produce an effect and the amount of spent toner increases. When the addition amount of dioctyltin compound exceeds 10.0 wt %, an effect on spent toner can be obtained; however, the amount of coating resin peeled increases and durability decreases.

In a carrier for an electrophotographic developer according to the present invention, the silicon content and dioctyltin content in the coating resin must satisfy the following expression:

0.5≦(dioctyltin content/silicon content)×100≦11.0

In the above expression, when a value of (dioctyltin content/silicon content)×100 is less than 0.5, the amount of spent toner increases. In contrast, when the value exceeds 11.0, amount of resin peeled increases and durability decreases.

Furthermore, the dibutyltin content in the coating resin above is desirably 1.0 ppm or less. It is not preferred that the content of dibutyltin exceeds 1.0 ppm, because the state of spent toner deteriorates and the charge amount after a duration test (toner life test) decreases.

In the present invention, in order to control the electric resistivity, charge amount and charging speed of a carrier, a conductive agent can be contained in a silicone resin or a modified silicone resin serving as a coating resin. The conductive agent, whose electric resistivity is low, is likely to cause rapid leakage of charge if it is excessively contained. Thus, the content of the conductive agent is 0.25 to 20.0 wt %, and preferably 0.5 to 15.0 wt % relative to the solid content of the coating resin. As the conductive agent, conductive carbon, oxides such as titanium oxide and tin oxide, and organic conductive agents are mentioned.

In the present invention, a charge controlling agent can be contained in the coating resin. As examples of the charge controlling agent, various types of charge controlling agents and silane coupling agents generally used for toner are mentioned. This is because the charging ability, which may sometimes decrease when a large amount of resin is used, can be controlled by adding a charge controlling agent and a silane coupling agent. The types of charge controlling agent and coupling agent to be used are not particularly limited; however a charge controlling agent such as nigrosine dye, a quaternary ammonium salt, an organic metal complex and a metal containing monoazo dye; and an aminosilane coupling agent and the like are preferable.

### <Electrophotographic Developer According to the Present Invention>

Next, an electrophotographic developer according to the present invention will be described.

An electrophotographic developer according to the present invention comprises the aforementioned carrier for an electrophotographic developer and a toner.

As the toner particles constituting the electrophotographic developer of the present invention, pulverized toner particles manufactured by a pulverizing method and polymer toner particles manufactured by a polymerization method are mentioned. In the present invention, toner particles obtained by either method can be used.

The pulverized toner particles can be obtained, for example, as follows. A binder resin, a charge controlling agent and a colorant are sufficiently mixed by a mixer such as Henschel mixer. The mixture is melt-kneaded by a twin screw extruder or the like, cooled, pulverized and classified. Thereafter, an external additive is added to the mixture and mixed by a mixer or the like to obtain the pulverized toner particles.

The binder resin constituting the pulverized toner particles is not particularly limited; however, polystyrene, chloropolystyrene, a styrene-chlorostyrene copolymer, a styrene-acrylate copolymer and a styrene-methacrylic acid copolymer are mentioned and further, a rosin modified maleic acid resin, an epoxy resin, a polyester resin and a polyurethane resin, etc. can be mentioned. These may be used alone or as a mixture.

As the charge controlling agent, any charge controlling agent can be used. For example, as the charge controlling agent for a positively charged toner, nigrosine dye and a quaternary ammonium salt, etc. can be mentioned. Furthermore, as the charge controlling agent for a negatively charged toner, a metal-containing monoazo dye and the like can be mentioned.

As the colorant (coloring material), dyes and pigments known in the art can be used. For example, carbon black, phthalocyanine blue, permanent red, chrome yellow, phthalocyanine green and the like can be used. Other than these, an external additive such as silica powder and titania can be added depending upon the toner particles in order to improve flowability and aggregation resistance of the toner particles.

Polymer toner particles are produced by a known method such as a suspension polymerization method, an emulsion polymerization method, an emulsion aggregation method, an ester elongation polymerization method and a phase inversion emulsification method. Such polymer toner particles can be obtained, for example, as follows. A colorant dispersion solution, in which a colorant is dispersed in water by use of a surfactant, is mixed with a polymerizable monomer, a surfactant and a polymerization initiator in an aqueous medium while stirring to emulsify and disperse the polymerizable monomer in the aqueous medium. After the monomer is polymerized while stirring and mixing, a salting agent is added to salt out polymer particles. The particles obtained by salting are filtrated, washed and dried to obtain the polymer toner particles. Thereafter, if necessary, an external additive is added to dried toner particles.

Furthermore, in manufacturing polymer toner particles, other than a polymerizable monomer, a surfactant, a polymerization initiator and a colorant, a fixability improving agent and a charge controlling agent can be blended. These agents contribute to controlling and improving properties of the resultant polymer toner particles. Furthermore, a chain transfer agent can be used for improving dispersibility of a polymerizable monomer in an aqueous medium and adjusting the molecular weight of the resultant polymer.

Although the polymerizable monomer to be used in manufacturing the polymer toner particles mentioned above is not particularly limited, for example, a styrene and a derivative thereof, an ethylene unsaturated mono-olefin such as ethylene and propylene, a vinyl halide such as vinyl chloride, a vinyl ester such as vinyl acetate and an α-methylene aliphatic monocarboxylate such as methyl acrylate, ethyl acrylate, methyl methacrylate, ethyl methacrylate, 2-ethylhexyl methacrylate, dimethylamino acylate, and diethylamino methacrylate can be mentioned.

As the colorant (coloring material) to be used for preparing the polymer toner particles as mentioned above, dyes and pigments known in the art can be used. For example, carbon black, phthalocyanine blue, permanent red, chrome yellow and phthalocyanine green can be used. Furthermore, these colorants may be improved in surface by use of a silane coupling agent and a titanium coupling agent, etc.

As the surfactant to be used for manufacturing the polymer toner particles as mentioned above, an anionic surfactant, a cationic surfactant, an amphoteric surfactant and a nonionic surfactant can be used.

As the anionic surfactant used herein, an aliphatic acid salt such as sodium oleate and castor oil; an alkyl sulfate such as sodium lauryl sulfate and ammonium lauryl sulfate, an alkyl benzene sulfonate such as sodium dodecyl benzenesulfonate, an alkyl naphthalene sulfonate, an alkyl phosphate, a naphthalene sulfonate-formalin condensation product and a polyoxyethylene alkyl sulfate, etc. can be mentioned. Furthermore, as the nonionic surfactant, a polyoxyethylene alkyl ether, a polyoxyethylene fatty acid ester, a sorbitan fatty acid ester, a polyoxyethylene alkylamine, glycerin, a fatty acid ester and an oxyethylene-oxypropylene block polymer, etc. can be mentioned. Furthermore, as the cationic surfactant, an alkyl amine salt such as lauryl amine acetate and a quaternary ammonium salt such as lauryl trimethylammonium chloride and stearyl trimethylammonium chloride, etc. can be mentioned. Furthermore, as the amphoteric surfactant, an aminocarboxylic acid salt, an alkyl amino acid and the like can be mentioned.

A surfactant as mentioned above can be used generally in an amount within the range of 0.01 to 10 wt % relative to the polymerizable monomer. The use amount of surfactant affects dispersion stability of a monomer and dependency of the resultant polymer toner particles on the environment. For this reason, the surfactant is preferably used in an amount within the aforementioned range in which dispersion stability of a monomer can be ensured and the dependency of the resultant polymer toner particles on the environment is not excessively affected.

In manufacturing of polymer toner particles, a polymerization initiator is generally used. As the polymerization initiator, a water-soluble polymerization initiator and an oil-soluble polymerization initiator are mentioned. Either polymerization initiator can be used in the present invention. As the water soluble polymerization initiator that can be used in the present invention, for example, a persulfate salt such as potassium persulfate and ammonium persulfate and a water-soluble peroxide compound can be mentioned. Furthermore, as the oil-soluble polymerization initiator, for example, an azo compound such as azobisisobutyronitrile and an oil-soluble peroxide compound can be mentioned.

Furthermore, when a chain transfer agent is used in the present invention, as the chain transfer agent, for example, a mercaptan such as octyl mercaptan, dodecyl mercaptan and tert-dodecyl mercaptan, and carbon tetrabromide can be mentioned.

Furthermore, when the polymer toner particles to be used in the present invention contain a fixability improving agent, as the fixability improving agent, a natural wax such as carnauba wax and a wax of an olefin such as polypropylene and polyethylene, etc. can be used.

Furthermore, when the polymer toner particles to be used in the present invention contain a charge controlling agent, the charge controlling agent to be used is not particularly limited. Nigrosine dye, a quaternary ammonium salt, an organic metal complex and a metal containing monoazo dye, etc. can be used.

Furthermore, as the external additive to be used for improving e.g., the flowability of polymer toner particles, silica, titanium oxide, barium titanate, fluorine resin microparticles and acrylic resin microparticles, etc. can be mentioned. These can be used alone or in combination.

Furthermore, as the salting agent for separating the polymer toner particles from an aqueous medium, a metal salt such as magnesium sulfate, aluminum sulfate, barium chloride, magnesium chloride, calcium chloride and sodium chloride can be mentioned.

The average size of the toner particles manufactured as mentioned above falls within the range of 2 to 15 μm and preferably 3 to 10 μm. Polymer toner particles are more uniform in particle size than pulverized toner particles. When the average size of toner particles is less than 2 μm, chargeability decreases and photographic fog and toner scattering are likely to occur. When the average size of toner particles exceeds 15 μm, image quality deteriorates.

The carrier manufactured as mentioned above and a toner are mixed to obtain an electrophotographic developer. The mixing ratio of the carrier and the toner, that is, a toner concentration, is preferably set at 3 to 15 wt %. When the concentration is less than 3 wt %, a desired image density cannot be obtained. When the concentration exceeds 15 wt %, toner scattering and photographic fog are likely to occur.

An electrophotographic developer according to the present invention can be used also as a replenishing developer. At this time, the mixing ratio of the carrier and the toner, that is, a toner concentration, is preferably set at 100 to 3000 wt %.

An electrophotographic developer according to the present invention prepared as mentioned above can be used in a digital copying machine, printer, FAX and printing presses, etc., employing a developing system, in which a latent image formed on a latent image holder and having an organic optical conductive layer is developed, in a phase inversion manner, by a magnetic brush of a two component developer having a toner and a carrier while applying a bias electric field. Furthermore, the electrophotographic developer can be used in a full color machine using an alternating electric field, which is a method of superimposing AC bias on DC bias, when a developing bias is applied to a latent image by a magnetic brush.

The present invention will be more specifically described based on Examples, below.

### Example 1

Appropriate amounts of raw materials were dry-blended such that the raw materials were contained in an amount of 39.7 mol % in terms of MnO, 9.9 mol % in terms of MgO, 49.6 mol % in terms of Fe₂O₃ and 0.8 mol % in terms of SrO, respectively. The mixture was pulverized by a dry-process vibration mill for 2 hours and granulated by a dry-process granulator to obtain granulates having a size of about 2 cm. The granulates were calcined by a rotary kiln furnace at 950° C. to obtain a calcined product. The calcined product was again pulverized by a wet-process ball mill for 2 hours to obtain slurry, which was dried by a spray dryer to obtain granulates. The granulates were sintered in a tunnel kiln furnace under a nitrogen atmosphere at 1300° C. for 3 hours and crushed. Thereafter, the particle size distribution of the granulates was controlled to obtain Mn—Mg—Sr ferrite particles (carrier core particles) having an average size of 60 μm.

Next, a methyl silicone resin (100 g on a solid basis) was weighed and dissolved in toluene (500 ml). To the mixture, further dioctyltin dineodecanoate (3.0 wt %) was added relative to the solid content of the methyl silicone resin to obtain a coating solution.

To the Mn—Mg—Sr ferrite particles (10 kg) obtained above, the coating solution obtained above was applied by a dip coating apparatus. Thereafter, the resultant particles were fired in a shelved drying chamber at 220° C. for 2 hours and crushed. Thereafter, the particle size distribution thereof was controlled to obtain a carrier for an electrophotographic developer. As shown in Table 1, the coating amount of resin relative to the carrier core particles is 1.0 wt %.

### Example 2

A carrier for an electrophotographic developer was manufactured in the same manner as in Example 1 except that the same carrier core particles as in Example 1 were used and dioctyltin dilaurate (3.0 wt %) was used as the dioctyltin compound, as shown in Table 1.

### Example 3

A carrier for an electrophotographic developer was manufactured in the same manner as in Example 1 except that the same carrier core particles as in Example 1 were used and dioctyltin diacetate (3.0 wt %) was used as the dioctyltin compound, as shown in Table 1.

### Example 4

A carrier for an electrophotographic developer was manufactured in the same manner as in Example 1 except that the same carrier core particles as in Example 1 were used and dioctyltin dineodecanoate (0.5 wt %) was used as the dioctyltin compound, as shown in Table 1.

### Example 5

A carrier for an electrophotographic developer was manufactured in the same manner as in Example 1 except that the same carrier core particles as in Example 1 were used and dioctyltin dineodecanoate (10.0 wt %) was used as the dioctyltin compound, as shown in Table 1.

### Example 6

A carrier for an electrophotographic developer was manufactured in the same manner as in Example 1 except that the same carrier core particles as in Example 1 were used and the coating amount of resin relative to the carrier core particles was set at 0.1 wt %, as shown in Table 1.

### Example 7

A carrier for an electrophotographic developer was manufactured in the same manner as in Example 1 except that the same carrier core particles as in Example 1 were used and the coating amount of resin relative to the carrier core particles was set at 3.5 wt %, as shown in Table 1.

### Example 8

A carrier for an electrophotographic developer was manufactured in the same manner as in Example 1 except that the same carrier core particles as in Example 1 were used and an acryl modified silicone resin (1.0 wt %) was used as the coating resin, as shown in Table 1.

### Example 9

A carrier for an electrophotographic developer was manufactured in the same manner as in Example 1 except that the same carrier core particles as in Example 1 were used and a fluorine modified silicone resin (1.0 wt %) was used as the coating resin, as shown in Table 1.

### COMPARATIVE EXAMPLE 1

A carrier for an electrophotographic developer was manufactured in the same manner as in Example 1 except that the same carrier core particles as in Example 1 were used and dioctyltin dineodecanoate (0.2 wt %) was used as the dioctyltin compound, as shown in Table 1.

### COMPARATIVE EXAMPLE 2

A carrier for an electrophotographic developer was manufactured in the same manner as in Example 1 except that the same carrier core particles as in Example 1 were used and dioctyltin dineodecanoate (12.0 wt %) was used as the dioctyltin compound, as shown in Table 1.

### COMPARATIVE EXAMPLE 3

A carrier for an electrophotographic developer was manufactured in the same manner as in Example 1 except that the same carrier core particles as in Example 1 were used and dibutyltin diacetate (3.0 wt %) was used, as shown in Table 1.

### COMPARATIVE EXAMPLE 4

A carrier for an electrophotographic developer was manufactured in the same manner as in Example 1 except that the same carrier core particles as in Example 1 were used and tetraalkylammonium salt ethyl cellosolve (4.5 wt %) was used, as shown in Table 1.

The coating resins (type, coating amount) of the carriers and catalysts (type, addition amount) of Examples 1 to 9 and Comparative Examples 1 to 4 are shown in Table 1. Furthermore, the carriers of Examples 1 to 9 and Comparative Examples 1 to 4, were checked for the silicon content, dioctyltin content, dibutyltin content, spent amount, external additive adhesion amount, the amount of resin peeled and charge amount (at initial, after 50K duration test (toner life test), durability).

The results of these and over-all judgment are shown in Table 2. The measurement method and evaluation method of these are as follows.

### (Silicon Content)

The silicon amount of carrier was determined based on the silicon quantification method (JIS G 1212-1997).

### (Dioctyltin Content and Dibutyltin Content)

### 1. Extraction Method

After a sample was ground on an agate dish, a predetermined amount of sample was taken and subjected to ultrasonic extraction with ethanol.

### 2. Pretreatment

### 2-1. General Reagent

Ethanol for use in test for remaining agricultural chemical 5000 (Kanto Chemical Co., Inc.)
Hexane for use in test for remaining agricultural chemical 5000 (Kanto Chemical Co., Inc.)
Diethylether for use in test for remaining agricultural chemical 5000 (Kanto Chemical Co., Inc.)
Purified water distilled water washed with hexane
Anhydrous sodium sulfate for use in test for remaining agricultural chemical (Kanto Chemical Co., Inc.)
Sodium acetate special grade reagent Kanto Chemical Co., Inc.)
Acetic acid special grade reagent (Kanto Chemical Co., Inc.)
Sodium tetraethylborateHayashi Pure Chemical Ind., Ltd.
Florisil PR for use in test for remaining agricultural chemical (Wako Pure Chemical Industries Ltd.)

### 2-2. Standard Substance

Di-n-octyltin oxide Tokyo Kasei Kogyo Co., Ltd.
Dibutyltin dichloride Tokyo Kasei Kogyo Co., Ltd.
Dibutyltin dichloride-d₁₈ Hayashi Pure Chemical Ind., Ltd.

### 2-3. Method

To a predetermined amount of extraction sample, an acetate buffer solution and a derivatization reagent were added and reacted for a predetermined time. The resultant reaction mixture was extracted with hexane and purified through a Florisil column.

### 3. Measurement

### 3-1. Measurement Conditions

The organic tin in a sample was measured by gas chromatography/mass spectrometry-selected ion monitoring (GC/MS-SIM) method.

### (GC Conditions)

Apparatus: HP 6890 Series GC System (manufactured by Hewlett Packard)

Column: HT-8, 25 m×0.22 mm I.D. 0.25 μm film-thickness (SGE)

Temperature raising conditions: 60° C. (2 min)→(10° C./min)→300° C.

Injection: injection amount: 1 μl, temperature: 260° C., injection mode: Splitless system

Carrier gas: He (1.2 mL/min) (MS Conditions)

Apparatus: AutoSpec Ultima (manufactured by Micromass)

Ionization system: EI system

Ionization voltage: 70 V

Ion source temperature: 280° C.

Detection mode: SIM

### 3-2. Identification and Quantification

Identification was performed in comparison with a chromatogram of a standard solution, more specifically, by comparing relative retention time of an emergent peak to that of the inner standard substance. Furthermore, the concentrations of dioctyltin and dibutyltin were obtained by the response factor method. The response factor method and quantification value were obtained based on the following computation expressions:

### (Response Factor (RF))

A standard sample was measured. Based on a peak area value of a target measurement substance and a peak area value of an internal standard substance, response factor was obtained in accordance with the following expression:

$$RF = \frac{A \times B}{C \times D}$$

### Wherein

A: Peak area value of target measurement substance
B: Amount of internal standard substance (ng)
C: Peak area value of internal standard substance
D: Amount of target measurement substance (ng)
(Quantification computation expression)

$$Detection amount ( ng ) = \frac{A \times B}{C \times RF}$$

### Wherein

A: Peak area value of target measurement substance
B: Amount of internal standard substance (ng)
C: Peak area value of internal standard substance

### (Charge Amount)

Charge amount was obtained by measuring an initial value and a value after toner life test (50 K) by means of Epping q/m-meter (suction type charge amount measuring apparatus (net: 795 meshes, suction force: 105±10 mbar, suction time: 90 seconds) manufactured by PES-Laboratoriumu). Furthermore, durability was obtained based on the following expression:

Durability(%)=(charge amount after 50K duration(toner life)test/initial charge amount)×100

### (Spent Amount)

Toner was removed by suction from the developer after a toner life test (performed at 50K) by use of a net of 795 meshes and the carrier after the toner life test was extracted. Thereafter, the amounts of carbon of the initial carrier and the carrier after the toner life test were measured by a carbon analyzer Type C-200 manufactured by LECO at an oxygen gas pressure of 2.5 kg/cm² and a nitrogen gas pressure of 2.8 kg/cm². The spent amount was calculated in accordance with the following expression:

$$Spent amount ( \% ) = \frac{A - B}{Carbon amount of carrier at initial time} \times 100$$

### Wherein

A: Carbon amount of carrier after toner life test
B: Carbon amount of carrier at initial time

### (Adhesion Amount of External Additive)

The adhesion amount of external additive can be measured by EZ scan, which is a contained-element scanning function of fluorescent X-ray analyzer Type ZSX 100e (manufactured by Rigaku Corporation). More specifically, toner was removed by suction from the developer after the toner life test (at 50 K) by use of a net of 795 meshes, and the carrier after the toner life test was extracted. Thereafter, the amounts of Ti of the initial carrier and the carrier after the toner life test were measured. First, a measurement sample was prepared by applying the carrier (particles) uniformly on the seal on a polyester film with an adhesive agent interposed between them. The measurement sample was set on a measurement sample bed. Measurement was performed under the following conditions (measurement range: F-U, measurement diameter: 30 mm, sample form: metal, measurement time: long, atmosphere: vacuum). The adhesion amount of external additive was obtained in accordance with the following expression:

$$Adhesion amount of external additive ( \% ) = \frac{A - B}{Intensity of Ti peak of initial carrier} \times 100$$

### Wherein

A: Intensity of Ti peak of carrier after toner life test
B: Intensity of Ti peak of initial carrier

### (Amount of Resin Peeled)

Toner was removed by suction from the developer after the toner life test (at 50 K) by use of a net of 795 meshes, and the carrier after the toner life test was extracted. Thereafter, the amount of silicon in the initial carrier and the carrier after the toner life test were measured based on the silicon quantification method (JIS G 1212-1997). The amount of resin peeled was calculated in accordance with the following expression:

Amount of resin peeled(%)=[(Si amount of carrier after toner life test)−(Si amount of initial carrier)]×100

### (Over-all Judgment)

In Over-all judgment, three levels for evaluation: Good (◯), acceptable (Δ), not acceptable (X) were used.

TABLE 1

| | Coating resin | | Hardening catalyst | |
|---|---|---|---|---|
| | | Coating amount | | Addition amount |
| | Type | (% by weight) | Type | (% by weight) |
| Example 1 | Methyl silicone resin | 1.0 | Dioctyltin dineodecanoate | 3.0 |
| Example 2 | Methyl silicone resin | 1.0 | Dioctyltin dilaurate | 3.0 |
| Example 3 | Methyl silicone resin | 1.0 | Dioctyltin diacetate | 3.0 |
| Example 4 | Methyl silicone resin | 1.0 | Dioctyltin dineodecanoate | 0.5 |
| Example 5 | Methyl silicone resin | 1.0 | Dioctyltin dineodecanoate | 10.0 |
| Example 6 | Methyl silicone resin | 0.1 | Dioctyltin dineodecanoate | 3.0 |
| Example 7 | Methyl silicone resin | 3.5 | Dioctyltin dineodecanoate | 3.0 |
| Example 8 | Acryl modified silicone | 1.0 | Dioctyltin dineodecanoate | 3.0 |
| | resin | | | |
| Example 9 | Fluorine modified | 1.0 | Dioctyltin dineodecanoate | 3.0 |
| | silicone resin | | | |
| Comparative | Methyl silicone resin | 1.0 | Dioctyltin dineodecanoate | 0.2 |
| Example 1 | | | | |
| Comparative | Methyl silicone resin | 1.0 | Dioctyltin dineodecanoate | 12.0 |
| Example 2 | | | | |
| Comparative | Methyl silicone resin | 1.0 | Dibutyltin diacetate | 3.0 |
| Example 3 | | | | |
| Comparative | Methyl silicone resin | 1.0 | Tetraalkylammonium salt | 4.5 |
| Example 4 | | | ethyl cellosolve | |

TABLE 2

| | | | | | | Adhesion | | | | | |
|---|---|---|---|---|---|---|---|---|---|---|---|
| | | | | | | amount of | Amount of | Charge amount | | | |
| | | | | Dioctyltin | Spent | external | resin | | 50K After | | |
| | Si | Dioctyltin | Dibutyltin | content/Si | amount | additive | peeled | | toner | | |
| | content | content | content | content | (% by | (% by | (% by | Initial | life test | Durability | Over-all |
| | (ppm) | (ppm) | (ppm) | (%) | weight) | weight) | weight) | (μC/g) | (μC/g) | (%) | judgment |
| Example 1 | 3300 | 92 | — | 2.8 | 5.0 | 767 | 15.0 | 39.62 | 37.57 | 94.81 | ◯ |
| Example 2 | 3300 | 97 | 0.08 | 2.9 | 7.0 | 1067 | 10.0 | 46.25 | 45.86 | 99.16 | ◯ |
| Example 3 | 3300 | 189 | — | 5.7 | 9.0 | 1500 | 7.5 | 36.72 | 32.34 | 88.07 | ◯ |
| Example 4 | 3300 | 16 | — | 0.5 | 12.5 | 1600 | 5.0 | 35.3 | 33.03 | 93.57 | ◯ |
| Example 5 | 3300 | 358 | — | 10.8 | 5.0 | 633 | 17.5 | 43.94 | 42.10 | 95.81 | ◯ |
| Example 6 | 527 | 12 | — | 2.3 | 13.0 | 1633 | 2.5 | 34.83 | 30.33 | 87.08 | ◯ |
| Example 7 | 10825 | 315 | — | 2.9 | 5.0 | 600 | 20.0 | 40.91 | 38.95 | 95.21 | ◯ |
| Example 8 | 3000 | 93 | — | 3.1 | 12.0 | 2433 | 5.0 | 38.1 | 32.85 | 86.22 | ◯ |
| Example 9 | 3100 | 91 | — | 2.9 | 4.5 | 733 | 15.0 | 32.6 | 31.63 | 97.02 | ◯ |
| Comparative | 3300 | 5 | — | 0.1 | 15.5 | 3633 | 10.0 | 32.92 | 27.07 | 82.23 | Δ |
| Example 1 | | | | | | | | | | | |
| Comparative | 3300 | 434 | — | 13.2 | 5.0 | 567 | 40.0 | 48.1 | 38.66 | 80.37 | Δ |
| Example 2 | | | | | | | | | | | |
| Comparative | 3300 | 0 | 104 | 0.0 | 23.5 | 4267 | 7.5 | 32.64 | 25.21 | 77.24 | X |
| Example 3 | | | | | | | | | | | |
| Comparative | 3300 | 0 | — | 0.0 | 29.5 | 5200 | 5.0 | 21.39 | 14.00 | 65.45 | X |
| Example 4 | | | | | | | | | | | |

As is apparent from the results shown in Table 2, the spent amount, adhesion amount of external additive and amount of resin peeled of each of Examples 1 to 9 are small. In addition, a reduction of charge amount with the passage of time is not significant. Therefore, over-all judgments are satisfactory.

In contrast, in Comparative Example 1, the spent amount and adhesion amount of external additive are large. In Comparative Example 2, the amount of resin peeled is large. Furthermore, in Comparative Examples 3 to 4, the spent amount and adhesion amount of external additive are large. In addition, in each of Comparative Examples 1 to 4, the charge amount decreases with the passage of time. Thus, over-all judgments of Comparative Examples are inferior to those of Examples 1 to 9.

A carrier for an electrophotographic developer according to the present invention and an electrophotographic developer using the carrier is capable of preventing spent toner, free of a significant reduction of charge amount and having excellent durability in long operating use.

A carrier for an electrophotographic developer according to the present invention and an electrophotographic developer using the carrier can be widely used in machines including a full-color machine requiring a high image quality and a high-speed machine requiring image maintenance reliability and durability.

1. A carrier for an electrophotographic developer, wherein a surface of a carrier core particle is coated with a silicone resin or a modified silicone resin, the coated resin containing a dioctyltin compound, and a silicon content and dioctyltin content in the coating resin satisfy the following expression:
0.5≦(dioctyltin content/silicon content)×100≦11.0

2. The carrier for an electrophotographic developer according to claim 1, wherein the dibutyltin content in the coating resin is 1.0 ppm or less.

3. An electrophotographic developer comprising the carrier according to claim 1 and a toner.

4. The electrophotographic developer according to claim 3 being used as a replenishing developer.

5. An electrophotographic developer comprising the carrier according to claim 2 and a toner.

6. The electrophotographic developer according to claim 5 being used as a replenishing developer.
